(19) United States
(12) Patent Application Publication
(10) Pub. No.: US 2008/0136327 A1
(43) Pub. Date: Jun. 12, 2008

(54) Plasma display panel

(76) Inventors: Sung-hyun Lim, Suwon-si (KR); Young-soo Seo, Suwon-si (KR); Joon-hyeong Kim, Suwon-si (KR); Tae-woong Jang, Suwon-si (KR); Ji-sung Ko, Suwon-si (KR); Kyu-hang Lee, Suwon-si (KR); Ho-seok Lee, Suwon-si (KR); Woo-sub Shin, Suwon-si (KR); Seung-uk Kwon, Suwon-si (KR); Ki-dong Kim, Suwon-si (KR)

Correspondence Address: ROBERT E. BUSHNELL, 1522 K STREET NW, SUITE 300, WASHINGTON, DC, 20005-1202, US

(21) Appl. No.: 11/896,112

(22) Filed: Aug. 29, 2007

(30) Foreign Application Priority Data
Dec. 6, 2006 (KR) 10-2006-0123181

(51) Int. Cl. H01J 17/49

(52) U.S. Cl. 313/582

(57) ABSTRACT

A plasma display panel (PDP) is capable of effectively reducing noise occurring during operation of the panel by improving the construction of a dummy partition included in a partition, and reduces a rate of defects in the partition due to a uniform coating of a fluorescent paste. The PDP includes: a front glass including sustain electrodes and dielectric layers; a rear glass including address electrodes and dielectric layers; a partition between the front and rear glasses and including a main partition and a dummy partition, each having discharge spaces of respective sizes; and a fluorescent layer coated on the respective discharge spaces.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 6^{th} of Dec. 2006 and there duly assigned Serial No. 10-2006-0123181.

### BACKGROUND OF THE INVENTION

1. Technical Field

The present invention relates to a plasma display panel and, more particularly, to a plasma display panel which increases productivity and product yield by improving an arrangement of a dummy partition wall included in a partition wall.

2. Related Art

In general, a plasma display panel (referred to as ‘PDP’ hereinafter) is a type of emitting device which displays color images using a gas discharge phenomenon in each cell. Since the PDP has a simple manufacturing process, high response speed, and a large-area screen, it is highlighted as an image display device.

The PDPs are classified into direct current (DC) and alternating current (AC) PDPs depending on driving waveform shapes and discharge cell structures.

Additionally, PDPs may be classified into facing and surface discharge PDPs depending on the arrangement of electrodes.

Among them, AC PDPs are a means to a display color image using a three electrode arrangement, and they have a construction that forms a partition in a panel, and an interior of the partition is coated with a fluorescent paste so that a fluorescent material emits light according to a power supply.

That is, the partition installed in the panel has approximately a lattice shape and includes a discharge space therein, which will be coated with a fluorescent paste. The discharge space is filled with mixing gas of Ne+Xe or He+Ne+Xe for generating ultraviolet rays with a constant pressure. Accordingly, when external electricity is supplied to the discharge space, the fluorescent material emits a visible ray to embody a still or moving image.

At this point, the partition can be coated with a fluorescent paste by a screen printing method or a dispenser injection method.

First, in the screen printing method, when a fluorescent paste starts to be discharged, a flexible screen pushes the fluorescent paste to fill the discharge space. Such a screen printing method has been most widely used since the initial development of the PDP.

As a panel becomes larger-size, the size of the screen should be larger. However, in this case, there is an inconvenience in manufacturing a screen corresponding to the size of the panel. Furthermore, when the screen moves, an imbalance of force occurs. Accordingly, it is difficult to uniformly fill the discharge space of a partition with the fluorescent paste.

Moreover, as the screen moves in such a way that it surface-contacts with an upper surface of the partition, a tension of a screen mask is increased, thereby reducing a life span thereof.

Accordingly, recently, instead of the screen printing method, most PDPs have been manufactured by the dispenser injection method.

The dispenser injection method is a method that fills a discharge space by discharging the fluorescent paste to a discharge space of the partition while moving a dispenser in a previously set direction.

A pattern and shape position of such a dummy partition is disclosed in U.S. Pat. No. 6,855,026 to Fujinaga et al. issued on Feb. 15, 2005.

### SUMMARY OF THE INVENTION

Accordingly, it is an aspect of the present invention to provide a plasma display panel which is capable of effectively reducing noise occurring during operation of the panel by improving the construction of a dummy partition included in a partition.

It is another object of the present invention to provide a plasma display panel which reduces a rate of defects in a partition due to a uniform coating of a fluorescent paste and continuously moves the dispenser in order to improve productivity.

The foregoing and/or other aspects of the present invention are achieved by providing a plasma display panel comprising: a front glass including sustain electrodes, each having X and Y electrodes, and dielectric layers for filling the sustain electrodes; a rear glass including address electrodes facing the sustain electrodes of the front glass so as to intersect each other, and dielectric layers for filling the address electrodes; a partition installed between the front glass and the rear glass, and including a main partition and a dummy partition, a plurality of discharge spaces having the same size being formed at the main partition, and a plurality of discharge spaces having different sizes being formed at the dummy partition; and fluorescent layers coated at the respective discharge spaces of the partition.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view of a procedure in which a fluorescent paste is coated along a moving path of a dispenser;

FIG. 2 is a partially enlarged view of a pattern of a dummy partition formed at a partition;

FIG. 3 is an enlarged schematic view of the dummy partition part in the plasma display panel;

FIG. 4 is a cross-sectional view of a plasma display panel according to the present invention;

FIG. 5 is a schematic view of a position of a dummy partition formed in a partition among structural elements of the plasma display panel according to the present invention;

FIG. 6 is an enlarged view of a dummy partition part of the partition according to the present invention; and

FIG. 7 is a schematic of a state in which the partition of the present invention is coated with a fluorescent material.

### DETAILED DESCRIPTION OF THE INVENTION

Hereinafter, preferable embodiments according to the present invention will be described with reference to the accompanying drawings. In the latter regard, when one element is connected to another element, one element may be not only directly connected to another element but also indirectly connected to another element via a further element. Moreover, irrelevant elements are omitted for clarity. Also, like reference numerals refer to like elements throughout.

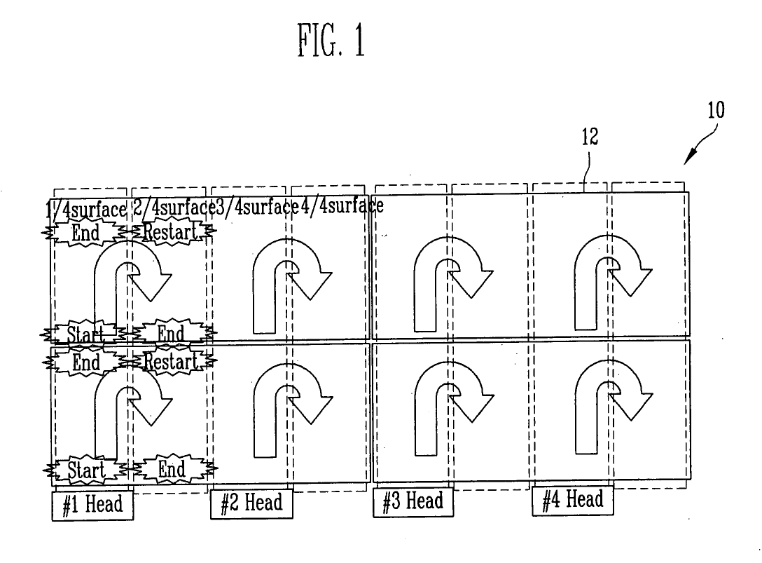

FIG. 1 is a schematic view of a procedure in which a fluorescent paste is coated along a moving path of a dispenser.

Referring to FIG. 1, when a partition 10 is put on a fluorescent paste coating device (not shown), for example, when one dispenser (not shown) is used, a dispenser advances from a side portion of the partition 10 to apply the fluorescent paste.

After the dispenser advances so as to completely apply the fluorescent paste, the dispenser moves to an adjacent position and then runs in a reverse direction to apply the fluorescent paste. In this respect, moving in the forward and reverse direction is referred to as “one cycle”.

When fluorescent paste is completely applied during one cycle by moving forward and backward, the dispenser moves to an adjacent position, which is not coated with the fluorescent paste. When the moving of the dispenser is terminated, an interior of the partition can be uniformly coated with the fluorescent paste by repeating the forward and backward movement.

At this point, a dummy partition 12 is formed at the partition 10 so as to uniformly coat it with the fluorescent paste. The dummy partition 12 is a preliminary region to be coated at the partition 10 so that the fluorescent paste can be initially discharged from the dispenser in a constant amount.

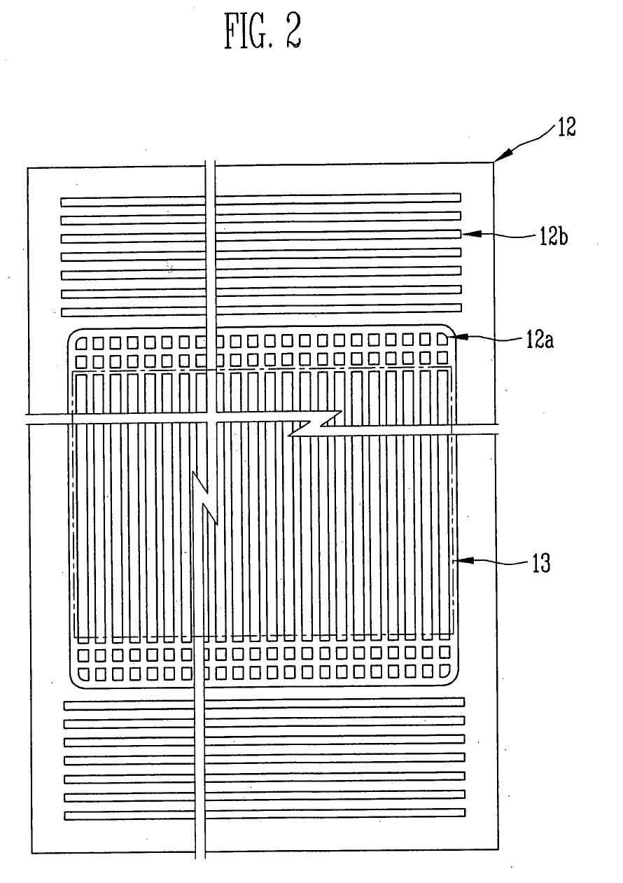

FIG. 2 is a partially enlarged view of a pattern of a dummy partition formed at a partition.

Referring to FIG. 2, sub partitions 12a are formed at both sides of a main partition 13, and auxiliary partitions 12b are formed at both sides of the sub partitions 12a. The dummy partition 12 is formed so as to include the sub partitions 12a and the auxiliary partitions 12b.

Thus, when a fluorescent paste is applied to the partition 10 using a dispenser of a paste coating device, the fluorescent paste is first moved and discharged in a transverse direction along a pattern of the auxiliary partition 12b. When the discharge in the transverse direction is completed, the fluorescent paste is again moved to the sub partition 12a and is discharged in a longitudinal direction. Then, the fluorescent paste is coated along a pattern of a main partition 13.

However, in a dummy partition 12, the dispenser passes through the transverse and longitudinal paths to first discharge the fluorescent paste. Accordingly, it takes a long time to coat the main partition with the fluorescent paste.

Namely, since the dummy partitions 13 are formed at both sides of the main partition 13 so as to have the same shape centered around the main partition 13. In this respect, the dummy partition 13 is composed of a sub partition 12a and an auxiliary partition 12b. Accordingly, although the main partition 13 is coated with fluorescent materials in the auxiliary partition 12b and the sub partition 12a, the sub partition 12a and the auxiliary partition 12b should be again coated with the fluorescent paste in the same manner as they were during a first discharge time of the dispenser.

Furthermore, as the dispenser passes through the transverse and longitudinal paths, a moving path thereof changes. Thus, the time required due to the direction change of the dispenser increases.

Accordingly, the time required may increase precision, but it will deteriorate the productivity of a display panel. Thus, there is a need for an improved plasma display panel in which both precision and productivity are increased.

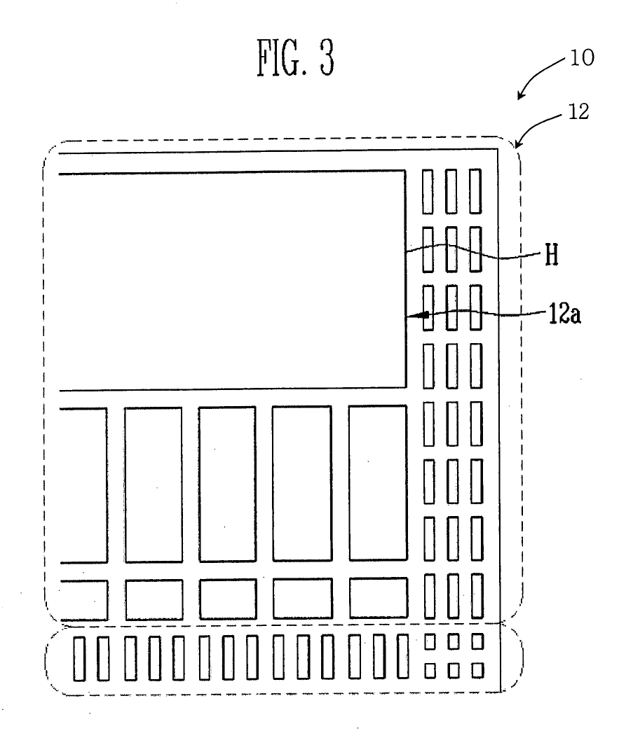

FIG. 3 is an enlarged schematic view of the dummy partition part in the plasma display panel.

FIG. 3 shows another embodiment of the plasma display panel, and is an enlarged schematic view of a dummy partition part in which only a sub partition is formed, whereas an auxiliary partition is omitted from the dummy partition.

A discharge space H of a sub partition becomes larger as the dummy partition 12 goes to an end portion of the partition 10. In particular, because an excitation can occur between the partition 10 and dielectric material during an assembly process of the panel, noise in the discharge space H of an end side increases.

Namely, in the plasma display panel, since the discharge space H of the end side of the partition 10 among discharge spaces of a sub partition has a box shape, which is not divided, there is no longitudinal partition adhered to the dielectric material so as to break a balance of force. The imbalance of force causes an excitation between the dielectric material and the partition 10. Accordingly, during operation of the panel, a vibration of the dielectric material and the partition causes a noise to occur.

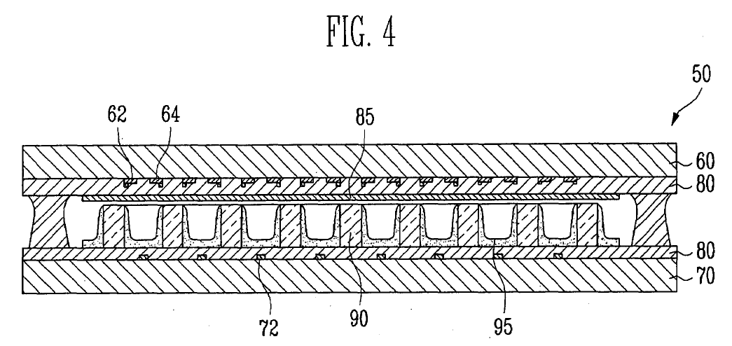

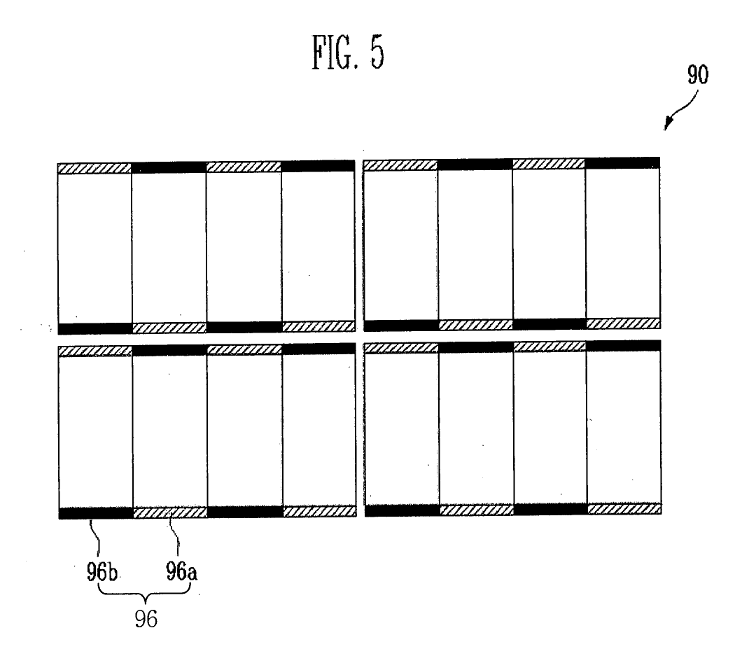

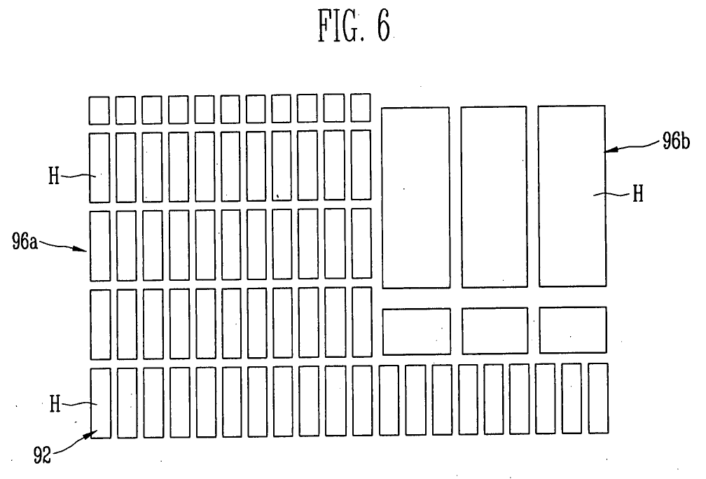

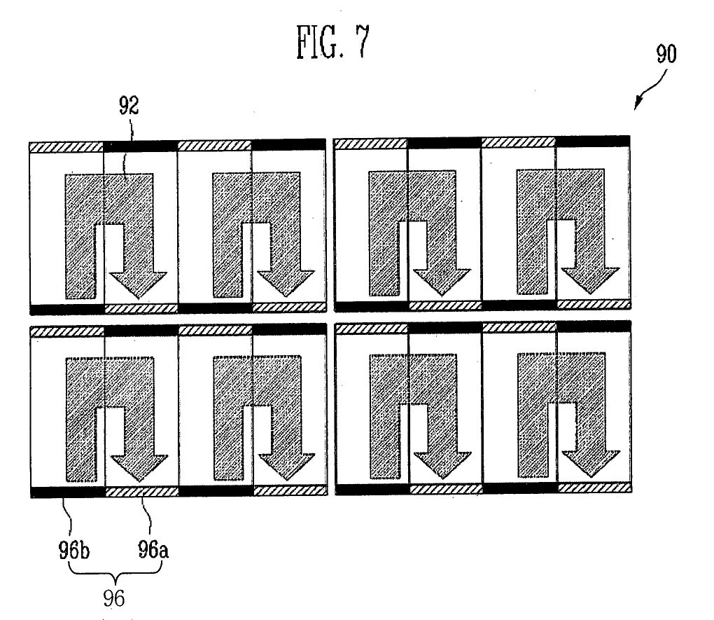

FIG. 4 is a cross-sectional view of a plasma display panel according to the present invention; FIG. 5 is a schematic view of a position of a dummy partition formed in a partition among structural elements of the plasma display panel according to the present invention; FIG. 6 is an enlarged view of a dummy partition part of the partition according to the present invention; and FIG. 7 is a schematic view of a state in which the partition of the present invention is coated with a fluorescent material.

Referring to FIG. 4, the plasma display panel 50 according to the present invention includes a front glass 60, a rear glass 70, dielectric layers 80, partitions 90, and fluorescent layers 95. The dielectric layers 80 are attached to the front glass 60 and the rear glass 70, respectively. The partitions 90 are installed between respective dielectric layers 80, and the fluorescent layers 95 are coated on the respective partitions 90.

The front glass 60 and the rear glass 70 are transparent glass, and both surfaces are arranged in parallel with each other so as to face each other at a predetermined interval.

Sustain electrodes 62 and 64 are installed on the front glass 60, and are composed of X and Y electrodes. Address electrodes 72 are installed on the rear glass 70 in correspondence to sustain electrodes 62 and 64 on the front glass 60.

The address electrodes 72 are arranged between the sustain electrodes 62 and 64. When an external power source is supplied to the address electrodes 72, they operate in correspondence with the sustain electrodes 62 and 64.

Dielectric layers 80 are formed at the front glass 60 and the rear glass 70, respectively, in order to fill the sustain electrodes 62 and 64 and the address electrodes 72.

A passivation layer 85 is formed on the dielectric layer 80 to protect a surface of the dielectric layer 80.

Frits (not shown) are installed at both ends of the front glass 60 and rear glass 70 in order to adhere the front glass 60 and rear glass 70 to each other.

In this regard, the partitions 90 are formed between the front glass 60 and the rear glass 70. Discharge spaces for emission of light by the sustain electrodes 62 and 64 and the address electrodes 72 are formed at each of the partitions 90.

The partitions 90 can be manufactured so as to have an approximately lattice shape. In this embodiment of the present invention, a lattice type partition is described. However, the present invention is not limited thereto.

The partitions 90 include main partitions 92 and dummy partitions 96 (see FIG. 5), which allows a screen to be outputted through front and rear panels. The dummy partitions 96 are formed at both ends of the main partition 92.

Discharge spaces H are formed at an upper surface of the main partition 92 (see FIG. 6). Fluorescent layers 95 are formed at the discharge space H and emit red (R), green (G), and blue (B) light.

The dispenser of the fluorescent paste coating device moves in the front and rear directions, and in the left and right directions, so as to inject fluorescent paste in the discharge spaces H, thereby forming fluorescent layers 95 (see FIG. 4).

In addition to the fluorescent layers 95, the discharge spaces H are filled with mixing gas of Ne+Xe or He+Ne+Xe to generate ultraviolet rays with a constant pressure.

The mixing gas is injected and filled in the discharge spaces H during a closed procedure of the front and rear panels 60 and 70, respectively.

Furthermore, dummy partitions 96 are formed at both ends of the main partition 92. Each of the dummy partitions 96 can be divided into a sub partition 96a and an auxiliary partition 96b (see FIG. 5).

Discharge spaces H are formed at the sub partition 96a (see FIG. 6). The discharge spaces H of the sub partition 96a are identical to, greater than or less than the discharge spaces of the main partition 92. The sub partition 96a is formed at an end position of the vertical movement of the dispenser.

Moreover, the auxiliary partition 96b is formed so as to have greater discharge spaces than those of the main partitions 92.

That is, the amount of fluorescent paste discharged from the dispenser is more than that of the fluorescent paste which is continuously discharged. In order to make the amount of fluorescent paste initially discharged uniform, the size of the discharge spaces H in the auxiliary partition 96b is controlled so as to be greater than that of the discharge spaces H in the main partitions 92.

In a detailed description of the auxiliary partition 96b, the discharge spaces H of the auxiliary partitions 96b are divided in the transverse and longitudinal directions. FIG. 6 shows a schematic of the size and shape of the auxiliary partition.

As shown in FIG. 6, the discharge spaces H of the auxiliary partition 96b extend in the transverse and longitudinal directions to form a plurality of discharge spaces H. In consideration of the travel direction and size of a nozzle (not shown) of the dispenser, it is preferred that the longitudinal width of each discharge space H be greater than the transverse width thereof.

Furthermore, along the travel direction of the dispenser, discharge spaces H of an end side of the auxiliary partition 96b gradually become smaller. The reason is that the paste initially discharged from the dispenser passes through large discharge spaces H so that a predetermined amount of the paste can be discharged.

The following is a procedure for coating a plasma display panel according to the present invention when constructed as described with a fluorescent paste.

When a moving robot (not shown) moves the partition 90 to a paste coating device, the user operates a controller (not shown) to move the dispenser to a previously set position.

When movement is completed, the dispenser advances from an auxiliary partition 96b of a dummy partition to coat the plasma display panel with the fluorescent paste.

In this regard, since the fluorescent paste in the dispenser is discharged by air pressure, the initial discharge amount thereof is relatively large. However, when the dispenser passes through the discharge spaces H of the auxiliary partition 96b, the fluorescent paste is uniformly discharged so as to coat the discharge spaces H of the main partition 92.

After all of the discharge spaces H of the main partition 92 are coated with the fluorescent paste, the dispenser is positioned at a formation point of the sub partition 96a, and the dispenser advances so as to continuously coat the interiors of the discharge spaces H of the sub partition 96a with the fluorescent paste.

When the dispenser advances so as to coat all interiors of the discharge spaces H of the sub partition 96a with the fluorescent paste, the dispenser is positioned so as to be completely spaced apart from the sub partition 96a.

Accordingly, the interiors of discharge spaces H of the partition 90 may be rapidly and uniformly coated with the fluorescent paste discharged through the dispenser. The discharge spaces H of the auxiliary partition 96b extend in the transverse and longitudinal directions. Accordingly, although the panel is adhered due to the maintenance of a balanced force, problems such as excitation do not occur.

On the other hand, the partition 90 of the present invention is divided into a plurality of blocks. As the dispenser reciprocates (one cycle), the interiors of the discharge spaces H of the main partition 92 may be rapidly coated with fluorescent paste.

That is, a main partition 92 of the partition 90 is divided into a plurality of blocks. The dispenser advances so as to apply the fluorescent paste, and is returned in an opposite direction to apply fluorescent paste, thereby minimizing movement of the dispenser. This causes a rapid coating to be performed.

In order to do this, auxiliary partitions 96b and sub partitions 96a should be alternately formed at both ends of the main partition 92, in which a plurality of blocks are divided.

A formation position of the dummy partition 96 can minimize the movement path of the dispenser.

Referring to FIG. 7, in the fluorescent material coating procedure using the dispenser, after the dispenser advances to coat the auxiliary partitions 96b, the main partitions 92, and the sub partition 96a, the dispenser moves to an adjacent position and is returned to its original position.

As the dispenser is returned to its original position, it passes through the auxiliary partitions 96b, the main partition 92, and the sub partitions 96a. Accordingly, although the dispenser repeats forward and backward movement, a continuous coating of the fluorescent paste can be performed.

Therefore, the dispenser minimizes the reciprocal movement distance and uniformly coats the partitions and sub partitions with the fluorescent paste.

As described above, in the plasma display panel according to an embodiment of the present invention, noise occurring during operation of the panel can be effectively reduced by improving the arrangement of the dummy partition included in the partition, thereby enhancing product yield.

Furthermore, uniform coating of the fluorescent paste can reduce the rate of defects of the partitions to a great extent, and can simplify the movement path of the dispenser, thereby improving productivity and providing satisfaction to manufacturers and users.

Although embodiments of the present invention have been shown and described, it will be appreciated by those skilled in the art that changes may be made in the embodiments without departing from the principles and spirit of the invention, the scope of which is defined by the claims and their equivalents.

What is claimed is:

1. A plasma display panel, comprising:
a front glass including sustain electrodes, each having X and Y electrodes, and dielectric layers for filling the sustain electrodes;
a rear glass including address electrodes facing the sustain electrodes of the front glass so that they intersect each other, and dielectric layers for filling the address electrodes;
a partition installed between the front glass and the rear glass, and including a main partition and a dummy partition, a plurality of discharge spaces having a same size being formed at the main partition, and a plurality of discharge spaces having different sizes being formed at the dummy partition; and
a fluorescent layer coated on the respective discharge spaces of the partitions.

2. The plasma display panel as claimed in claim 1, wherein the dummy partition includes an auxiliary partition and a sub partition, the auxiliary partition being formed at a coating start position of a fluorescent paste and being composed of a discharge space greater than a discharge space of the main partition, and the sub partition being formed at a coating end position of the fluorescent paste and including a discharge space having a same size as a size of the discharge space of the main partition.

3. The plasma display panel as claimed in claim 2, wherein the auxiliary partition includes a plurality of discharge spaces which are divided into discharge spaces extending in a transverse direction and discharge spaces extending in a longitudinal direction.

4. The plasma display panel as claimed claim 3, wherein a size of a discharge space of the auxiliary partition becomes less as the fluorescent paste is applied at the coating end position.

5. The plasma display panel as claimed in claim 4, wherein a longitudinal width of the discharge space of the auxiliary partition is greater than a transverse width of the discharge space of the auxiliary partition in a coating direction of the fluorescent paste.

6. The plasma display panel as claimed in claim 3, wherein a longitudinal width of the discharge space of the auxiliary partition is greater than a transverse width of the discharge space of the auxiliary partition in a coating direction of the fluorescent paste.

7. The plasma display panel as claimed in claim 2, wherein a size of a discharge space of the auxiliary partition becomes less as the fluorescent paste is applied at the coating end position.

8. The plasma display panel as claimed in claim 7, wherein a longitudinal width of the discharge space of the auxiliary partition is greater than a transverse width of the discharge space of the auxiliary partition in a coating direction of the fluorescent paste.

9. The plasma display panel as claimed in claim 2, wherein a longitudinal width of the discharge space of the auxiliary partition is greater than a transverse width of the discharge space of the auxiliary partition in a coating direction of the fluorescent paste.

10. The plasma display panel as claimed in claim 1, wherein a size of a discharge space of the auxiliary partition becomes less as the fluorescent paste is applied at the coating end position.

11. The plasma display panel as claimed in claim 10, wherein a longitudinal width of the discharge space of the auxiliary partition is greater than a transverse width of the discharge space of the auxiliary partition in a coating direction of the fluorescent paste.

12. The plasma display panel as claimed in claim 1, further comprising a passivation layer formed at the dielectric layers of the front glass to protect a surface thereof.

13. The plasma display panel as claimed in claim 1, further comprising frits installed at both ends of the front and rear glasses in order to adhere the front and rear glasses to each other.

14. A plasma display panel, comprising:
a front glass including sustain electrodes, each having X and Y electrodes;
a rear glass including address electrodes;
dielectric layers installed at the front and rear glasses in order to fill the sustain electrodes and the address electrodes;
a partition divided into a plurality of blocks and including a main partition and a dummy partition, the dummy partition being alternately formed at both ends of the plurality of blocks; and
a fluorescent layer coated at a discharge space of the partition.

15. The plasma display panel as claimed in claim 14, wherein the dummy partition includes an auxiliary partition and a sub partition, the auxiliary partition being formed at a coating start position of a fluorescent paste and composed of a discharge space greater than a discharge space of the main partition, and the sub partition being formed at a coating end position of the fluorescent paste and including a discharge space having a same size as a size of the discharge space of the main partition.

16. The plasma display panel as claimed in claim 15, wherein the auxiliary partition includes a plurality of discharge spaces which are divided into discharge spaces extending in a transverse direction and discharge spaces extending in a longitudinal direction.

17. The plasma display panel as claimed in claim 16, wherein a size of a discharge space in the auxiliary partition becomes less as the fluorescent paste is applied at coating end position.

18. The plasma display panel as claimed in claim 17, wherein a longitudinal width of the discharge space of the auxiliary partition is greater than a transverse width of the discharge space of the auxiliary partition in a coating direction of the fluorescent paste.

19. The plasma display panel as claimed in claim 16, wherein a longitudinal width of the discharge space of the auxiliary partition is greater than a transverse width of the discharge space of the auxiliary partition in a coating direction of the fluorescent paste.

20. The plasma display panel as claimed in claim 15, wherein a size of a discharge space in the auxiliary partition becomes less as the fluorescent paste is applied at coating end position

21. The plasma display panel as claimed in claim 20, wherein a longitudinal width of the discharge space of the auxiliary partition is greater than a transverse width of the discharge space of the auxiliary partition in a coating direction of the fluorescent paste.

22. The plasma display panel as claimed in claim 15, wherein a longitudinal width of the discharge space of the auxiliary partition is greater than a transverse width of the discharge space of the auxiliary partition in a coating direction of the fluorescent paste.

23. The plasma display panel as claimed in claim 14, wherein a size of a discharge space in the auxiliary partition becomes less as the fluorescent paste is applied at coating end position.

24. The plasma display panel as claimed in claim 23, wherein a longitudinal width of the discharge space of the auxiliary partition is greater than a transverse width of the discharge space of the auxiliary partition in a coating direction of the fluorescent paste.

25. The plasma display panel as claimed in claim 14, further comprising a passivation layer formed at the dielectric layers of the front glass to protect a surface thereof.

26. The plasma display panel as claimed in claim 14, further comprising frits installed at both ends of the front and rear glasses in order to adhere the front and rear glasses to each other.
